(19) United States
(12) Patent Application Publication
(10) Pub. No.: US 2021/0252820 A1
(43) Pub. Date: Aug. 19, 2021

(54) A TAMPING ASSEMBLY

(71) Applicants: SCITECH CENTRE, Mumbai (IN); ACG PAM PHARMA TECHNOLOGIES PVT LTD, Mumbai (IN)

(72) Inventors: Karan SINGH, Mumbai (IN); Prakash DESHMUKH, Mumbai (IN); Manish PRAJAPATI, Mumbai (IN)

(21) Appl. No.: 16/973,786

(22) PCT Filed: Oct. 1, 2019
(86) PCT No.: PCT/IB2019/058333

§ 371 Date: Dec. 10, 2020

(30) Foreign Application Priority Data
Oct. 11, 2018 (IN) 201821038692

(51) Int. Cl. B30B 11/12; B30B 1/28; A61J 3/07; B30B 1/14

(52) U.S. Cl. CPC B30B 11/12; B30B 1/14; A61J 3/074; B30B 1/28

(57) ABSTRACT

A tamping assembly for capsule filling machine is provided. The tamping assembly comprises a fixed base/platform for accommodating a dosing disc assembly; a movable platform disposed above the fixed platform, the movable platform having plurality of sets of top tamping plungers; a pair of movable rods extending from the movable platform; and a lifting assembly mounted below the fixed base, and operably connected with the pair of movable rods for lifting/lowering the movable rods and/or the movable platform, the lifting assembly comprising a pair of first link members, each first link member extends along an incline from a first end to a second end, at the first end each first link members is pivotally mounted below the fixed base; a pair of second link members, each second link member extends from a proximal to a distal end, the proximal end of each second link member pivotally coupled with the second end of the each link member via a first pivot rod, and the distal end of each second link member pivotally coupled with each movable rod via a second pivot rod; and a drive mechanism connected with the second end of each first link member for moving the first link members, movement of the first link member causes the second member to lift or lower the movable platform, and thereby the tamping assembly.

### FIELD OF THE INVENTION

The invention relates to a tamping assembly for a capsule filling machine.

### BACKGROUND OF THE INVENTION

Capsules containing pharmaceutical formulations in the form of products such as micro-tablets, mini tablets, tablets, caplets, soft gels, pellets, spherical balls and filled capsules are known and generally used for controlled drug delivery. Capsule filling machines are widely used to precisely fill such pharmaceutical formulations in gelatin capsules.

Typically, a capsule filling machine comprises of a central turret or carousel with capsule handling units and plurality of processing or operating stations positioned around periphery of the turret. The turret rotates intermittently, carrying the capsule handling unit to each of the processing or operating stations. Each of the processing stations have equipment or machinery to carry out a dedicated operation. Such operations include capsule loading, capsule opening, capsule filling—powder filling or pellet filling, capsule closing, capsule rejection and capsule ejection.

Equipment or machinery at the processing station for powder filling comprises a tamping assembly. The tamping assembly comprises of a hopper, a container, a dosing disc, a bottom plate, and plurality of set of top tamping plungers. The powder to be filled in the capsules is first loaded into a hopper which is then transferred to the container. The dosing disc is provided with a plurality of sets of through vertical passages which are equidistantly placed around the periphery of the dosing disc. The bottom plate is provided below the dosing disc so as to close the vertical passages in the dosing disc at the bottom thereof expect the vertical passages which align with the capsule handling unit. Mounted above the dosing disc are the plurality of sets of vertical plungers (pistons) disposed in the same layout as the sets of vertical passages in the dosing disc. The plungers are mounted on a movable platform, whereby the movable platform is lifted or lowered to move the plungers up and down. The movable platform is typically moved by a cam mechanism or a crank mechanism. However, the force exerted by these mechanisms for tamping action is not as efficient. The plungers are height adjustable and movable up and down. The lower ends of the plungers are profiled to pass through the vertical passages.

In a cycle of operation of the machine, one set of vertical passages of the dosing disc is filled up with the powdery product and respective set of plungers move down and press the powdery product to form a slug into the corresponding sets of vertical passages in layers or stages of increased quantity until the last set of the vertical passages among the remaining set of vertical passages is completely filled with the powdery product to the required dose and at the last stage the slug is delivered into the capsule container. This is called the tamping operation. Following this the plungers move up and the carousels rotate by a predetermined angle. This is called the indexing operation. The said last set of the vertical passages among the remaining set of vertical passages filled with the powdery product to the required, moves back to its original position, the capsule bottoms are closed with the capsule tops in the respective upper capsule holder and the closed capsules are expelled from the capsule handling carousel. While, tamping is achieved with the aforementioned setup, as mentioned hereinbefore the force exerted by these mechanisms for tamping action is not as efficient. This affects integrity of the slug formed. In view of the aforementioned, there is a need in the art to address at-least the aforementioned issues.

### SUMMARY OF THE INVENTION

Accordingly, the present invention in one aspect provides a tamping assembly for a capsule filling machine, the tamping assembly comprising: a fixed base/platform for accommodating a dosing disc assembly; a movable platform disposed above the fixed platform, the movable platform having plurality of sets of top tamping plungers; a pair of movable rods extending from the movable platform; and a lifting assembly mounted below the fixed base, and operably connected with the pair of movable rods for lifting/lowering the movable rods and/or the movable platform, the lifting assembly comprising: a pair of first link members, each first link member extends along an incline from a first end to a second end, at the first end each first link members is pivotally mounted below the fixed base; a pair of second link members, each second link member extends from a proximal to a distal end, the proximal end of each second link member pivotally coupled with the second end of the each link member via a first pivot rod, and the distal end of each second link member pivotally coupled with each movable rod via a second pivot rod; and a drive mechanism connected with the second end of each first link member for moving the first link members, movement of the first link member causes the second member to lift or lower the movable platform, and thereby the tamping assembly.

### BRIEF DESCRIPTION OF THE DRAWINGS

Reference will be made to embodiments of the invention, examples of which may be illustrated in accompanying figures. These figures are intended to be illustrative, not limiting. Although the invention is generally described in context of these embodiments, it should be understood that it is not intended to limit the scope of the invention to these particular embodiments.

FIG. 1 shows a capsule filling machine in accordance with an embodiment of the invention.

FIG. 2 shows a tamping assembly in accordance with an embodiment of the invention.

FIG. 3 shows a side view of a tamping assembly in a lifted position in accordance with an embodiment of the invention.

FIG. 4 shows a side view of a tamping assembly in a lowered position in accordance with an embodiment of the invention.

### DETAILED DESCRIPTION OF THE INVENTION

The present invention is directed towards a tamping assembly for a capsule filling machine.

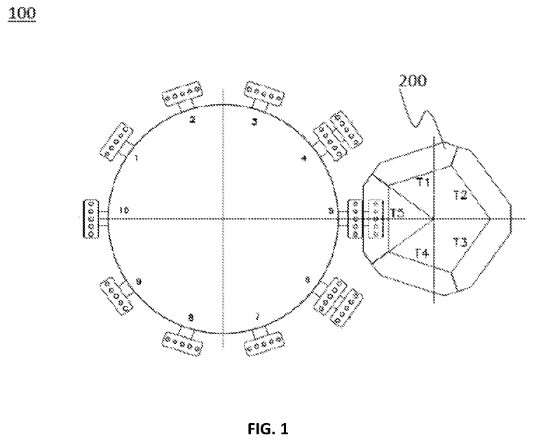

FIG. 1 shows a capsule filling machine 100 in accordance with an embodiment of the invention. The capsule filling machine comprises a central turret or carousel and plurality of processing stations 1 to 10 or more as per requirement positioned around periphery of the turret. The turret is provided with plurality of capsule handling units disposed equidistantly around the periphery thereof. Each of the capsule handling unit comprises two superimposed capsule holders (bodies). The upper capsule holders are fixed to the carousel and are provided with bushes or seatings to hold the capsule tops and the lower capsule holders are provided with bushes or seatings to hold the capsule bottoms. The turret rotates intermittently, carrying the capsule handling unit to each of the processing stations.

Processing station denoted by numeral 1 is a capsule loading station where empty gelatin capsules are supplied. Processing station denoted by numeral 3 is a capsule opening station where cap and body segments of capsules are separated. Processing station denoted by numeral 4 to 7 are filling stations where products such as powder, pellets, tablet etc. are filled in the capsules. As per the present invention, the capsule filling machine is configured for powder filling in capsules Processing station denoted by 5 is a powder filling station where powder is filled by a tamping assembly 200. The tamping assembly has plurality of tamping stations T1 to T6. Processing station denoted by numeral 8 is a capsule closing station where split capsule holders are joined again ensuring the capsule cap fits on the capsule body and closes the capsule, after which the capsules are ejected at processing station 9. Processing station 10 is provided for cleaning of cap and body bushes by air and vacuum. It will be appreciated that, in the system illustrated through the figures a total of ten processing stations are provided, the number of processing stations may be varied depending upon requirement.

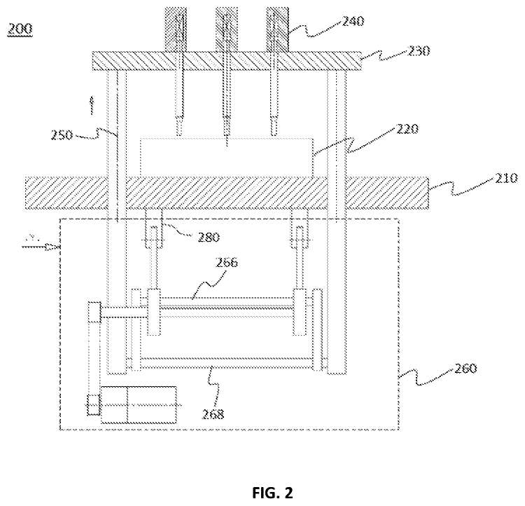

FIGS. 2 to 4 show a tamping assembly 200 in accordance with an embodiment of the invention. As discussed hereinbefore, the capsule filling machine is configured for filling powdered products. Accordingly, the processing station 5 will include the tamping assembly shown through FIG. 2 to 4. The tamping assembly comprises of a fixed platform 210, a dosing assembly 220, a movable platform 230, plurality of sets of tamping plungers 240, a pair of movable rods 250, and a lifting assembly 260.

As shown, the fixed platform accommodates the dosing disc assembly. The dosing disc assembly comprises of a powder tub, a dosing disc, and a bottom plate. The powder to be filled in the capsules is first loaded into a hopper which is then transferred to the powder tub. The powder tub is mounted on the fixed platform. The dosing disc has plurality of sets of through vertical passages. The dosing disc is rotatably mounted on a vertical shaft and is configured to move/rotate sequentially, whereby the vertical shaft is driven by an indexing unit to rotate the dosing disc intermittently. The bottom plate is disposed below the dosing disc. The bottom plate is movable up and down. A nut is provided for moving the bottom plate up and down, whereby a pneumatic cylinder drives the nut. The bottom plate is moved up and down to generate a gap between the dosing disc and the bottom plate to allow the dosing disc to rotate, and close the gap during tamping to eliminate powder spillage, as disclosed in earlier patent application no 1033/MUM/2006. The bottom plate has an opening aligned with the carousel which is adjacent to the tamping assembly; and a set of apertures aligned with at-least one set of through vertical passage of the dosing disc. In the remaining areas, the bottom plate closes the vertical passages of the dosing disc at the bottom thereof.

The dimensions of the vertical passages of the dosing disc and the apertures of the bottom plate are a function of the mass of the doses of the powdery product to be filled in the capsules and a function of the dimensions of the capsules themselves.

As shown, the movable platform is disposed above the fixed platform and has plurality of sets of tamping plungers. The movable platform is configured to move up and down with respect to the fixed platform. Thus, the sets of tamping plungers are adapted above the dosing disc assembly, and are movable up and down about the dosing disc assembly. Further, as shown, the pair of movable rods extend from the movable platform. In this regard, each movable rod extends from a top end to a bottom end. At the top end, the movable platform is mounted. As the movable rod extends, the movable rods pass through and beyond the fixed platform through a pair of holes provided on the fixed platform. The movable rods are lifted or lowered to move the movable platform up and down, and thereby the movable platform having the tamping plungers.

As shown in the figure, the lifting assembly is provided below the fixed base and operably connected with the movable rods for lifting/lowering the movable rods and thereby the movable platform having the tamping plungers. The lifting assembly comprises of a pair of first link members 262, a pair of second link members 264, and a drive mechanism 270. The pair of first link members extend along an incline from a first end to a second end. At the first end, each first link member is pivotally mounted below the fixed platform. A pair of hinges 280 are provided on the fixed platform for mounting the first link members.

The pair of second link members extend from a proximal end to a distal end. The proximal end of each second link member is pivotally coupled with the second end of each first link member via a first pivot rod 266. At the distal end, each second link member is pivotally connected with each movable rod via a second pivot rod 268. In this regard, the first pivot acts as a central pivot for the lifting assembly. As shown, the first end of the first link member is adapted to the bottom of the fixed platform, and the distal end of the second link member is adapted to the movable rods. Accordingly, when a force is applied at the second end of each first link member, the first link member and the second link member will rotate about the first pivot rod. Further, the second link member will also rotate about the first pivot and simultaneously move the movable rod, thereby moving the movable platform having the sets of tamping plungers. The movement of the links exerts maximum force on the movable platform, especially when the movable platform is moved downwards, thereby improving the tamping carried out by the tamping plungers.

Further, a driving mechanism is connected with the second end of each first link member for moving the first link members. Movement of the first link member causes the second member to lift or lower the movable rods, and thereby the set of tamping plungers. The driving mechanism is configured to move with predetermined acceleration and defined stroke, thereby moving the set of tamping plungers with predetermined acceleration and defined stroke.

The driving mechanism comprises a pair of disks 272, an eccentric shaft and a servo drive 276. Each disc has a rod 274 extending therefrom which is connected with first link member. Further, the eccentric shaft interconnects the pair of disks. The eccentric shaft on one side is connected with the servo drive via a pulley 278. Accordingly, the servo drive rotates the pair of disks via the pulley, and the rotation of the disk causes, the connecting rods to move back and forth with predetermined acceleration and defined stroke, and thereby the set of tamping plungers.

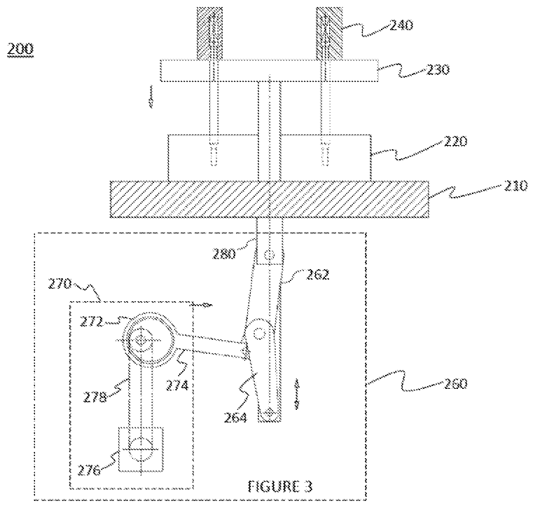

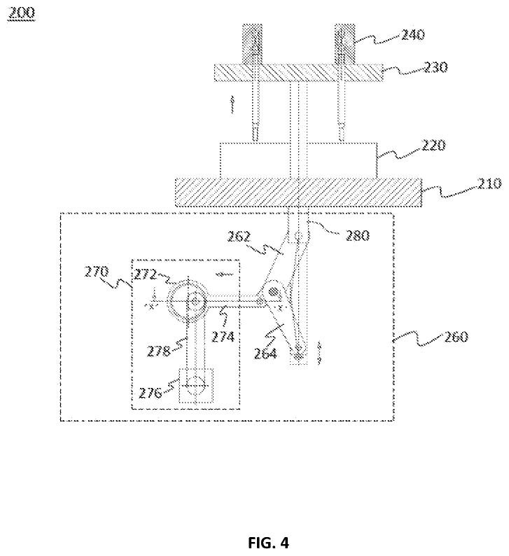

In operation, particularly to lower the movable platform i.e. lower the sets of tamping plungers towards the dosing assembly, the drive mechanism is actuated. Upon actuation, the servo drive rotates the pulley which causes the disks to rotate. Rotation of the disc causes the connecting rod to push the first link members and the second link member which lowers the movable rods. The movable platform with the tamping plungers will thus be pulled towards the dosing assembly as shown in FIG. 3. At this position, the lifting mechanism exerts maximum force on the movable platform, thereby improving the tamping efficiency carried out by the tamping plungers. Further, to lift the movable platform i.e. lift the sets of tamping plungers away from the dosing assembly, the drive mechanism is actuated. Upon actuation, the servo drive rotates the pulley in the opposite direction which causes the disks to rotate. Rotation of the disc causes the connecting rod to pull the first link members, and the second link member which lifts the movable rods. The movable platform with the tamping plungers will thus be pushed away from the dosing assembly as shown in FIG. 4.

While the present invention has been described with respect to certain embodiments, it will be apparent to those skilled in the art that various changes and modification may be made without departing from the scope of the invention as defined in the following claims.

We claim:

1. A tamping assembly for a capsule filling machine, the tamping assembly comprising:
a fixed base/platform for accommodating a dosing disc assembly;
a movable platform disposed above the fixed platform, the movable platform having plurality of sets of top tamping plungers;
a pair of movable rods extending from the movable platform; and
a lifting assembly mounted below the fixed base, and operably connected with the pair of movable rods for lifting/lowering the movable rods and/or the movable platform, the lifting assembly comprising:
a pair of first link members, each first link member extends along an incline from a first end to a second end, at the first end each first link members is pivotally mounted below the fixed base;
a pair of second link members, each second link member extends from a proximal to a distal end, the proximal end of each second link member pivotally coupled with the second end of the each link member via a first pivot rod, and the distal end of each second link member pivotally coupled with each movable rod via a second pivot rod; and
a drive mechanism connected with the second end of each first link member for moving the first link members, movement of the first link member causes the second member to lift or lower the movable platform, and thereby the tamping assembly.

2. The system as claimed in claim 1, wherein the driving mechanism comprising:
pair of disks having a rod extending from each disk, each rod connected with each first link member,
an eccentric shaft interconnecting the pair of disks;
a servo drive connected with the eccentric shaft via a pulley to rotate the pair of disks, the rotation of the disk causes the shaft to move back and forth, and thereby moving the movable rods and/or movable platform.

3. The system as claimed in claim 1, wherein the driving mechanism is configured to move with predetermined acceleration and defined stroke.
